(19) United States
(12) Patent Application Publication
(10) Pub. No.: US 2005/0119918 A1
(43) Pub. Date: Jun. 2, 2005

(54) Payment management system and method

(76) Inventor: Roger D. Berliner, Asheboro, NC (US)

Correspondence Address: LAW OFFICES OF ROYAL W. CRAIG;A PROFESSIONAL CORPORATION, SUITE 153, 10 NORTH CALVERT STREET, BALTIMORE, MD, 21202, US

(21) Appl. No.: 10/982,705

(22) Filed: Nov. 5, 2004

Related U.S. Application Data
(60) Provisional application No. 60/518,481, filed on Nov. 7, 2003.

(51) Int. Cl. G06F 17/60

(52) U.S. Cl. 705/3

(57) ABSTRACT

A patient-centric, community-based system and method that professionally and effectively manages and services all patient-pay receivables associated with an individual's healthcare. The system permits patients to charge all out-of-pocket expenses for medical goods or services from different providers to one convenient, Patient Account, thereby reducing patient/responsible party confusion and permitting a single monthly payment. The Patient Accounts are “owned” pro rata by the healthcare providers in accordance with the respective amounts owed to each. The system employs a method for applying payments from the patient/responsible party and/or other payors to providers based on specific contractual arrangements, and real-time reporting of Patient Accounts status/activity via secure, proprietary Internet access. By centralizing account management functions, each of the providers is spared the costs of establishing his/her/its own discrete, separate and redundant patient account, the periodic mailing of invoices, the processing of payments, the dunning of past due accounts, and the application to Medicare and Medicaid for reimbursement.

### CROSS-REFERENCE TO RELATED APPLICATIONS

The present application derives priority from U.S. Provisional Patent Application No. 60/518,481, filed Nov. 7, 2003.

### BACKGROUND OF THE INVENTION

1. Field of the Invention

The present invention relates to payment management systems and, more particularly, to a payment management system and method for use in the field of healthcare services, and even more particularly, to a patient-centric system and method for managing and servicing all patient-pay receivables associated with an individual's healthcare.

2. Description of the Background

In recent years, healthcare and, in particular, the source of the funds needed to pay for it have represented significant political issues among those that govern the United States. This is due, in part, to the rising median age of the American population and the increased demand for and, therefore, cost of healthcare required by an aging population. To pay the increasing costs associated with healthcare, American society has created a patchwork system for compensating healthcare providers for their goods and services. The system includes, among others, payments from HMOs, PPOs, indemnity insurance, and the U.S. government. However, due to the independent nature of the American population, society finds it appropriate for those individuals who have actually used the healthcare system to shoulder some personal financial responsibility.

The patient-pay portion (i.e. paid by the patient himself/herself, or a legally responsible party such as a parent or guardian) represents a significant percentage of all healthcare revenue. Among healthcare providers, the patient-pay portion is projected, by 2007, to represent approximately 25% of $2.1 trillion, or $525 billion in healthcare-related billings. While American Health Institute studies have suggested that 65% of patients have the financial capacity to pay their fair share, the haphazard, inequitable, and ineffective management of the current patient-pay process is projected, again by 2007, to generate $130 billion in healthcare delivery system losses.

The haphazard, inequitable, and ineffective management of the patient-pay portion of the healthcare delivery system is the result of positioning health care providers (e.g. doctors, hospitals, etc.) as lenders or creditors. Unfortunately, the knowledge and skills required to become an effective lender/creditor are not part of the typical medical school curriculum and, therefore, providers are forced to master a discipline outside their core competency. While some are successful in mastering this new discipline, most are not. Providers that fail to become effective lenders/creditors experience increased expenses resulting in a loss of income. Providers that are overzealous in their attempts at debt collection (i.e. charging or dunning patients regardless of their ability to pay) face the possibility of alienating patients/responsible parties and the loss of the third party payments (e.g. HMOs, PPOs, Medicare and Medicaid) associated with the care of those patients. Furthermore, federal regulations associated with the writing off bad debt and the claiming of charitable allowances are complex and costly.

Additional governmental barriers associated with the patient-pay portion of healthcare include the Centers for Medicare/Medicaid Services (CMS) regulations. The Reimbursement Payment Code, 42 C.F.R. 413.80 and Section 300, is an outmoded and costly model. For example, as required by the Code, a single hospital stay generates a number of separate debts and a subsequent series of collection efforts which are conducted as prescribed by a set of procedures, a patient's/responsible party's economic capacity to pay is not considered. Within this federally mandated system, individual states have no incentive to try to improve the system, healthcare providers “go through the motions,” and the taxpayers foot the bill.

Efforts to overcome the problems associated with healthcare payment management have resulted in variety of systems and/or methods and, therefore, the present inventor is not the first to address the issue. For example, systems and methods for this purpose are found in U.S. Pat. No. 6,208,973 to Boyer et al., U.S. Pat. No. 6,012,035 to Freeman, Jr. et al., and U.S. Pat. No. 5,583,760 to Klesse.

U.S. Pat. No. 6,208,973 to Boyer et al. discloses a point of service third party adjudicated payment system and method which provides for the creation of an adjudicated settlement transaction at a point of service which designates the portion of the service to be paid by the third party payor and the portion to be paid by the customer. The system includes a point of service terminal which accepts a payment system access card, such as a credit card, debit card, or purchase card, for payment for a purchase of a service and/or product by a customer, where at least part of the purchase is reimbursable by a third party payor. The payment system access card provides access to a payment system which transfers funds in accordance with the adjudicated settlement transaction whereby the third party payor is debited by the first portion and the point of service provider is paid the first portion and a payment account accessible by the payment system access card is charged at least the second portion and the point of service provider is paid the second portion as with typical payment card transactions.

U.S. Pat. No. 6,012,035 to Freeman, Jr. et al. discloses the effectuation of a health care provision agency cooperative function that is established through a communication network linking all the various entities of the cooperative. The entities include the third party payor members, the health providing individuals, clinics, or the like, along with secondary providers including pharmacies and laboratories, health care facilities such as hospitals, and the several entities associated with management of the cooperative and appropriate funds transfer functions. A coordinating interface system maintains data storage of the necessary information, and manages the entity intercommunications in accordance with the basic structure of the active and eligible elements of the agency cooperative.

U.S. Pat. No. 5,583,760 to Klesse discloses a data processing system that establishes and administers charge accounts, including both funded and post-funded accounts. In one embodiment, the system of the invention establishes charge accounts for all of the patients of a medical professional, with creditworthy patients having funded accounts, and patients who are not creditworthy having post-funded accounts. Each patient is issued a charge card which can be used to pay for medical services at participating providers. When a patient with a funded account charges medical services, the doctor is paid promptly and the servicing company proceeds to collect payment from the patient. For post-funded accounts, the doctor is not paid until funds are received from the patient.

Unfortunately, despite the existence of more effective and efficient technologies and systems, there is no way to rationalize the current multi-party billing and servicing process. The known prior art does not provide for (1) a Patient Account that is “owned” by all healthcare providers delivering services to that patient, (2) the payment of all interest income, collected from patients/responsible parties in the course of servicing their accounts, to the various providers, (3) applying payments from patients/responsible parties and/or other payors to the various providers based upon specific contractual arrangements, and (4) the determination of a patient's/responsible party's ability to pay, or that that ability has been exceeded, at the time of a provider transaction.

To the best of the knowledge of the present inventor, no prior system and method exists to address the issues and problems outlined above. Consequently, it would be greatly advantageous to provide a healthcare payment management system and method in which (1) each Patient Account is “owned” by all healthcare providers delivering services to that patient according to a mutually agreed upon prorating of the providers' respective interests, (2) all interest income collected from patients/responsible parties in the course of servicing their accounts is forwarded to the various providers, (3) the structure for applying payments from patients/responsible parties and/or other payors to the various providers is based upon specific contractual arrangements, and (4) a patient's/responsible party's ability to pay (i.e. as defined by local/state policy under the supervision of the Centers for Medicare and Medicaid Services), or that that ability has been exceeded, may be determined at the time of a provider transaction.

### SUMMARY OF THE INVENTION

It is, therefore, the primary object of the present invention to provide an improved payment management system and method with applications in business scenarios where interrelated products and/or services are essential and indivisible.

Another object of the present invention is to provide a healthcare payment management system and method that rationalizes the current multi-party billing and servicing process associated with the patient-pay portion of healthcare.

A further object of the present invention is to provide a system and method that establishes and manages multiple Patient Accounts.

Yet another object of the present invention is to provide a system and method in which each Patient Account is “owned” by all healthcare providers delivering services to that patient according to a mutually agreed upon proration of the providers' respective interests.

Another object of the present invention is to provide a system and method in which all interest income collected from patients/responsible parties in the course of servicing their accounts is forwarded to the various providers.

Still another object of the present invention is to provide a system and method that applies payments from patients/responsible parties and/or other payors to the various providers in accordance with specific contractual arrangements.

It is another object of the present invention to provide a system and method by which a patient's/responsible party's ability to pay may be determined at the time of a provider transaction.

Yet another object of the present invention is to provide a system and method that can determine that a patient's/responsible party's ability to pay has been exceeded at the time of a provider transaction.

Another object of the present invention is to provide a system and method that eliminates the needless dunning of those patients/responsible parties unable to pay their healthcare debts.

Still another object of the present invention is to provide a system and method that lessens patient/responsible party confusion by providing a consolidated statement showing all current healthcare debts.

It is another object of the present invention to provide a system and method that decreases paperwork and operating expenses incurred by healthcare providers, thereby increasing their income.

Another object of the present invention is to provide a system and method that implements contemporary credit management tactics/regulations and information technology.

Still another object of the present invention is to provide a system and method that relieves taxpayers of the non-public costs associated with healthcare.

An additional object of the present invention is to provide a system and method that is easy to use to provide for ready acceptance among healthcare providers.

According to the present invention, the above-described and other objects are accomplished by a patient-centric, community-based payment management system and method that professionally and effectively manages and services all patient-pay receivables associated with an individual's healthcare, thereby improving patient-provider relations. The present invention is a national shared services initiative, supporting physicians, hospitals, and other members of the healthcare community.

The present invention permits patients to charge all out-of-pocket expenses for medical goods or services from different participating providers to one convenient, Patient Account, thereby reducing patient/responsible party confusion and permitting a single monthly payment. The system and method of the present invention includes a flexible revolving credit program with reasonable interest rates. For example, if a patient incurs additional charges or insurance pays more (or less), the balance due is automatically adjusted or additional credit is extended to the patient/responsible party. The present invention refunds to patients/responsible parties any previously paid interest that is subsequently paid by a third party and provides real-time (i.e. on-line) coordination of multiple bills for one or more family members.

Each Patient Account is “owned” by all participating healthcare providers delivering services to that patient in accordance with a mutually agreed upon (i.e. contractual agreement) proration of their respective interests. Additionally, the providers receive all interest income generated in Patient Accounts. By centralizing certain account management functions, each of the participating providers is spared the costs of establishing a Patient Account, the periodic mailing of invoices, the processing of payments, the dunning of past due accounts, and the application to Medicare and Medicaid for reimbursement of uncollectible services. The present invention allows these functions to be performed with a consistent level of professionalism, up-to-date information technology, economies of scale, and proportional expense sharing to reduce operating expenses. There are no budgetary constraints or initial out-of-pocket expenses required to become a participant in the present invention. The present invention automatically enrolls all patients/responsible parties, including existing self-pay balances, of participating healthcare providers.

The present invention includes a method for applying payments from the patient/responsible party and/or other payors to participating providers based on specific contractual arrangements. The present invention improves collections and produces more accurate financial reporting through the use of proven consumer credit technologies, systems, and structure. The present invention objectively quantifies a patient's/responsible party's ability to pay health care expenses, and actively manages proportional expense sharing and lending, utilizing underlying patient-pay receivables.

The present invention's reporting capability/functionality, via secure, proprietary Internet access, provides real-time information regarding Patient Account status/activity to providers or patients/responsible parties. The invention's independent, third-party system/method analyzes each patient's/responsible party's ability to pay and is structured to collect either 95% of an individual's healthcare expenses based on that ability to pay or an amount determined by public (i.e. CMS) policy. The percentage of an individual's health care expenses that the present invention is structured to collect and the amount determined by public/CMS policy are subject to change. The present invention provides healthcare providers and society in general with the comfort of knowing that those who have used the healthcare system are paying their fair share according to their ability.

The present invention possesses applications beyond the field of healthcare. The central element/feature is the establishment and management of a single product/service receiver account, or Patient Account, jointly owned, as defined in a contractual agreement, by a set of product/service providers. It may be applied in any business scenario where interrelated products/services are essential and indivisible (e.g. one would never have surgery without anesthesia). Those scenarios make it possible, practical, and extremely beneficial to have one account per product/service receiver. All product/service providers benefit from the elimination of redundant processes such as the mailing of invoices, the processing of payments, and the dunning of past due accounts.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a schematic representation of a payment management system 15 that manages and services all patient-pay receivables associated with an individual's healthcare, according to a preferred embodiment of the present invention.

FIG. 2 is a schematic representation of a Patient Account 20, as shown in FIG. 1, according to a preferred embodiment of the present invention.

FIG. 3 shows a flowchart of a process 100 for establishing the Patient Account 20 of FIG. 1, according to a preferred embodiment of the present invention.

FIG. 4 shows a flowchart of a process 120 for utilizing the Patient Account 20 of FIG. 1 during an interaction between a patient and a provider, according to a preferred embodiment of the present invention.

FIG. 5 shows a flowchart of a process 160 for utilizing the Patient Account 20 of FIG. 1 in the collection and disbursement of payments made by a patient/responsible party, according to a preferred embodiment of the present invention.

FIG. 6 shows a schematic summarizing the flow of information and funds between the payment management system 15 of FIG. 1, a patient/responsible party 25, and a plurality of healthcare providers 30-33.

FIGS. 7A-7C collectively are a generic example of a contractual Agreement used in the system and method of the present invention.

### DETAILED DESCRIPTION OF THE PREFERRED EMBODIMENTS

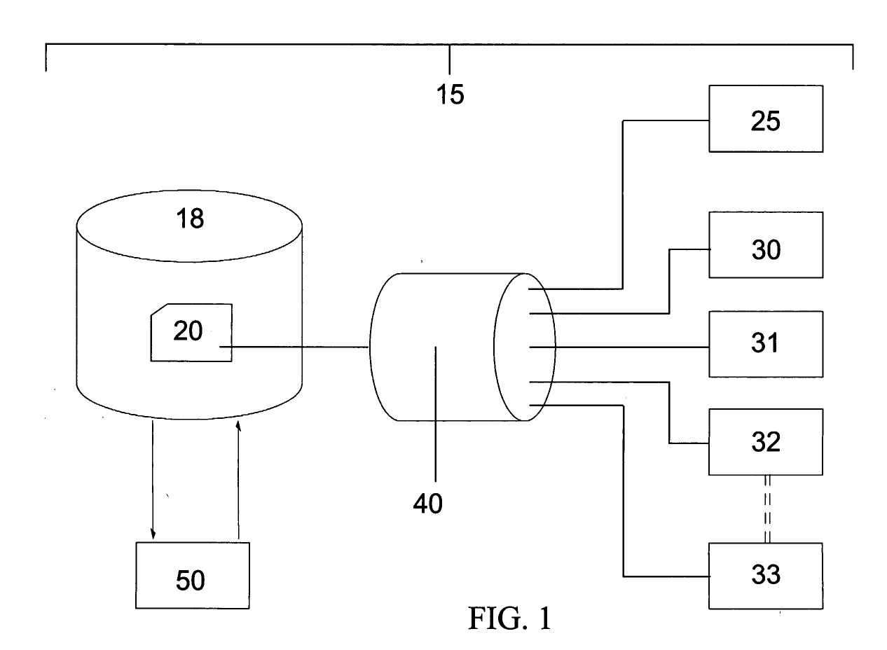

FIG. 1 is a schematic representation of the patient-centric, community-based payment management system 15, according to a preferred embodiment of the present invention, that professionally and effectively manages and services all patient-pay receivables associated with an individual's healthcare. The present invention is intended to be a national shared services initiative that improves patient-provider relations and supports physicians, hospitals, and other members of the healthcare community. The payment management system 15 employs a computer architecture comprising a central database 18 for Patient Account data 20, a patient/responsible party 25, a plurality of healthcare providers 30-33, real-time network access to the Patient Accounts 20 by the patient/responsible party 25 and the plurality of providers 30-33 via, for example, the Internet 40, and network access to database 18 by a credit reporting service 50. The central database 18 and the Patient Account 20 information stored therein is preferably maintained using commercially-available database management software such as Database Server from MySQL AB of Sweden, SQL Server 2000 from Microsoft Corporation of Redmond, Wash., Oracle Database from Oracle Corporation of Redwood Shores, Calif., or DB2 from IBM of Armonk, N.Y., and commercially-available financial transactions software such as BASE24 from ACI Worldwide of Omaha, NB. The database management and financial transactions software is resident on the hard drive of a commercially-available computer/server that is preferably a Windows industry standard server, a Linux server, or a proprietary Unix server that is scalable, redundant, and readily available. The credit reporting service 50 may be any one of the well-established organizations such as Trans Union, Equifax, or Experian.

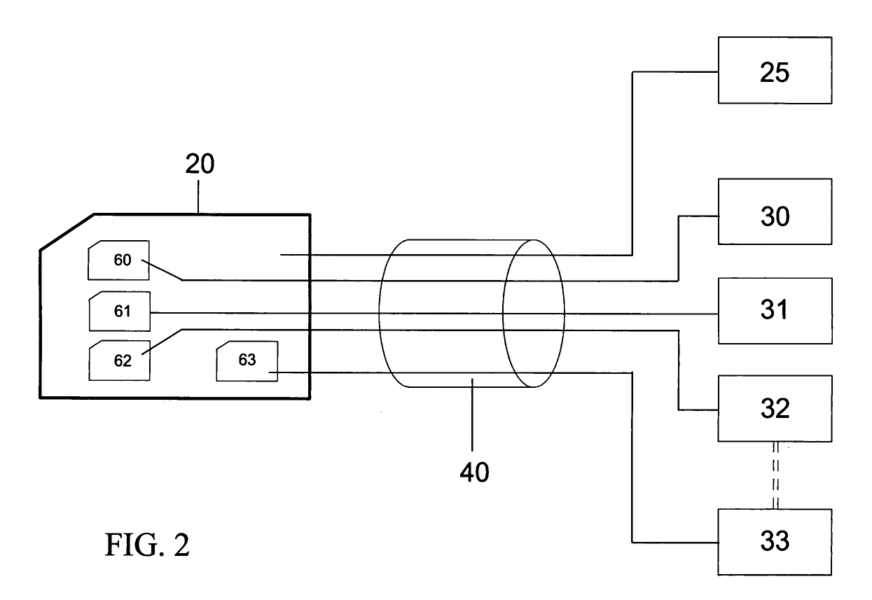

FIG. 2 is a schematic representation of the Patient Account 20 showing additional detail as to the links between the contents of the Patient Account 20 and the patient/responsible party 25 and the plurality of providers 30-33. The Patient Account 20 comprises a plurality of patient-provider accounts 60-63 each comprising account information for a specific one of the plurality of healthcare providers 30-33. The patient/responsible party 25 may access any information in the Patient Account 20, in real-time, via a secure, proprietary connection to the Internet 40. Likewise, any one of the plurality of providers 30-33 may access the Patient Account 20 via a secure, proprietary connection to the Internet 40. However, provider 30-33 access is limited to only that information found in the corresponding patient-provider account 60-63 (i.e. provider 31 may access the information contained in corresponding patient-provider account 61; provider 31 may not access the information contained in patient-provider accounts 60, 62, and 63).

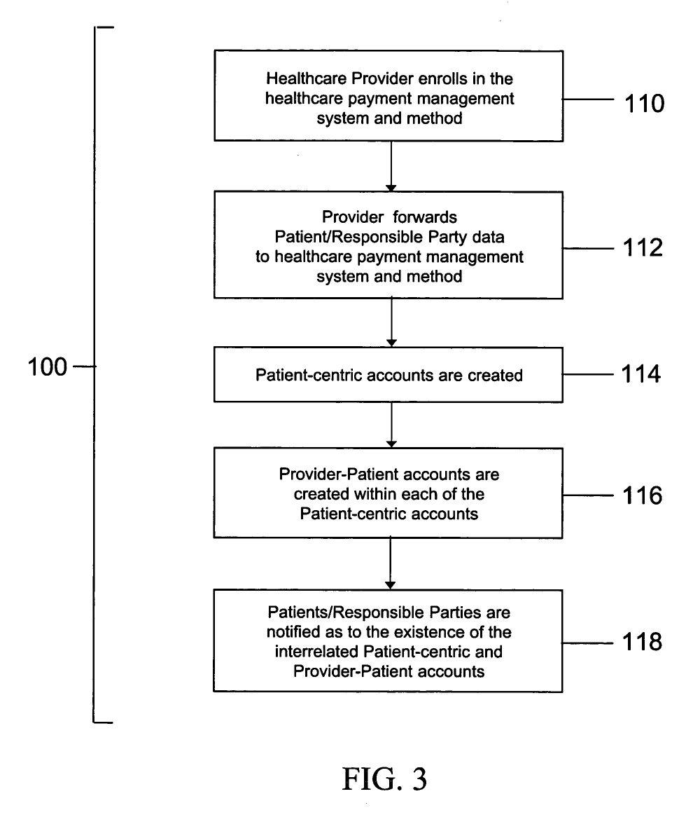

FIG. 3 shows a flowchart of the process 100 for establishing a Patient Account 20 of FIG. 1. With collective reference to FIGS. 1-3, the process 100 begins, at step 110, with a healthcare provider 30-33 deciding to make use of the present invention to manage his/her/its patient-pay receivables. The enrollment process is accomplished by a payor enrollment interface for allowing additional providers to enroll in the payment management system and submit their own provider-patient accounts to the payor-centric account. The interface allows the provider 30-33, at step 112, forwards patient-pay receivables data (e.g. patient and/or responsible party name, address, outstanding patient-pay balance) for entry into the system's database 18. The data is utilized in the creation of a plurality of Patient Accounts 20 at step 114 to populate central database 18. Subsequent to the creation of the Patient Accounts 20, at step 116, a plurality of provider-patient accounts 60-63 is created within the primary Patient Accounts 20. As additional providers 30-33 enroll in the payment management system 15, each newly submitted provider-patient account 60-63 is added to the existing Patient Account 20 data. In addition, all newly submitted provider-patient account 60-63 data including patient names is compared to those already in the database 18. This may be accomplished using conventional mail merge software with programmable matching rule set. When a newly submitted patient name matches an existing one, the new provider-patient account 60-63 is added to the existing Patient Account 20 and is linked by database field to the existing provider-patient account.

Finally, at step 118, the patients/responsible parties 25 are notified in writing of the existence of the various accounts. That written notification typically includes a complete disclosure of all of the rules and regulations (e.g. late payment definition/penalties, financing/interest rate, minimum periodic finance charge) associated with the operation of the accounts.

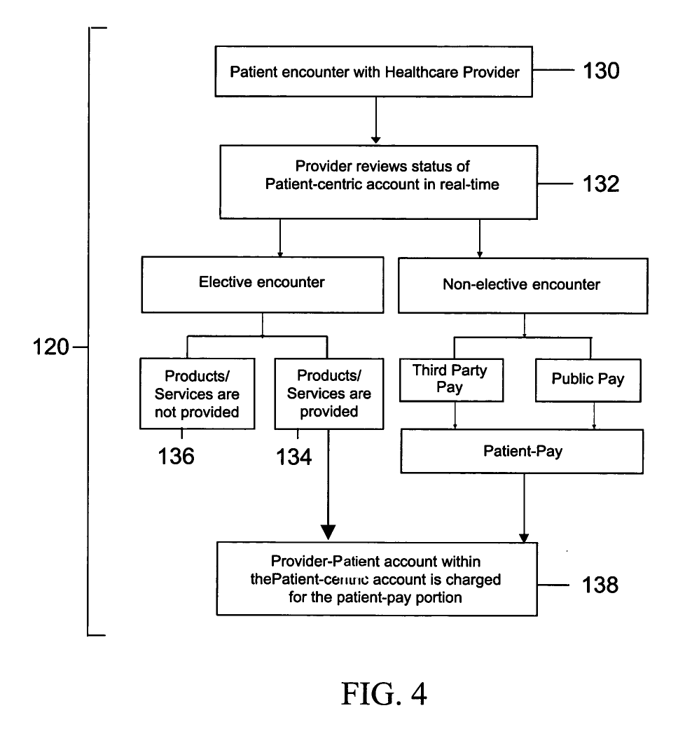

FIG. 4 shows a flowchart of a process 120 for utilizing the Patient Accounts 20 of FIG. 1 during an interaction between a patient and a provider. With collective reference to FIGS. 2 and 4, the process 120 begins with an encounter between a patient 25 and an enrolled (i.e. participating) healthcare provider 30-33 at step 130. If, at step 132, the products/services required by the patient 25 are deemed to be elective in nature, the provider 30-33, at step 140, typically elects to review the status of the provider-patient account 60-63, in real-time, via a secure, proprietary, Internet 40-based connection prior to providing any products or services. This allows the provider 30-33 to obtain outstanding balance and/or ability-to-pay information in order to make an informed business decision (i.e. one balancing the provider's right to be paid for products/services rendered vs. the needs of the patient at that moment). If, at step 142, the status of the provider-patient account 60-63 is found to be unacceptable (e.g. extremely past due, uncollectable), the provider 30-33 may elect not to supply the patient 25 with any products or services at step 148. Alternatively, if the status of the provider-patient account 60-63 is found to be acceptable at step 142, the provider 30-33 may supply to the patient 25, at step 144, any required products and/or services. Once the products and/or services have been supplied at step 144, the appropriate provider-patient account 60-63 within the Patient Accounts 20 is charged for the patient-pay portion of the product/service costs at step 146.

However, if, at step 132, the products/services required by the patient 25 are deemed to be non-elective in nature, the provider 30-33 must supply those products and/or services to the patient 25 at step 134. Once the products and/or services have been supplied at step 134, the appropriate provider-patient account 60-63 within the Patient Account 20 is charged for the patient-pay portion of the product/service costs at step 136. In non-elective circumstances, where the delivery, or non-delivery, of the required products and/or services does not lie within the discretion of the provider 30-33, the remainder of the cost of those products/services, over and above that charged to the appropriate provider-patient account 60-63, are borne by the public or an appropriate third party at step 138.

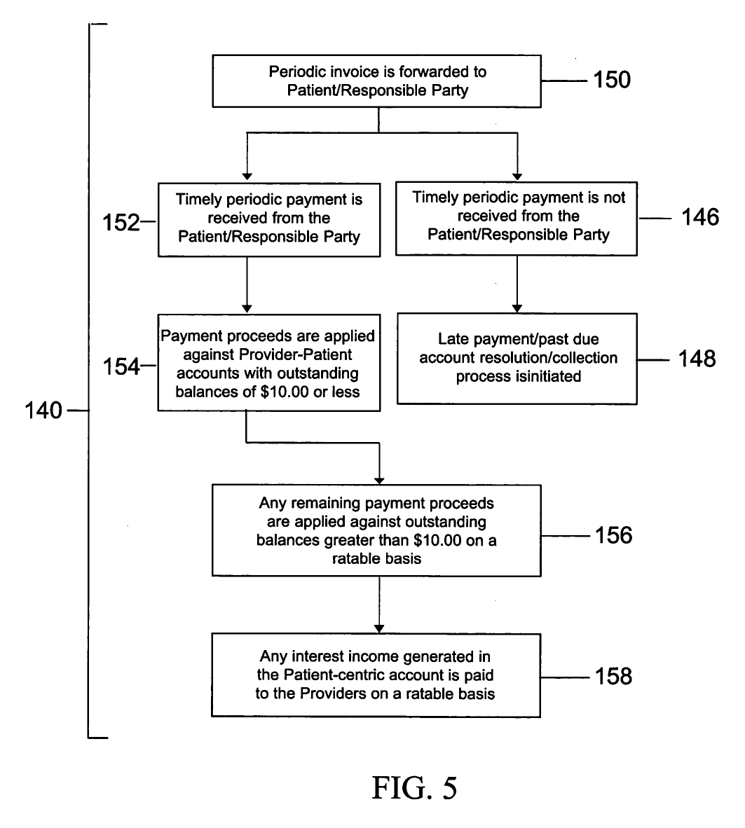

FIG. 5 shows a flowchart of a process 160 for utilizing the Patient Account 20 of FIG. 1 in the collection and disbursement of payments made by a patient/responsible party. With collective reference to FIGS. 2 and 5, the process 160 begins, at step 150, with the forwarding of a periodic invoice to the patient/responsible party 25. Once a timely, periodic payment has been received from the patient/responsible party 25 at step 152, the proceeds of that payment are applied against provider-patient accounts 60-63 with outstanding balances of $20.00 or less at step 154. If the payment proceeds are insufficient to satisfy all of the provider-patient accounts 60-63 with outstanding balances of $20.00 or less, the proceeds are distributed among those accounts 60-63 on a ratable basis. If the payment proceeds are sufficient to satisfy all of the provider-patient accounts 60-63 with outstanding balances of $20.00 or less, at step 156 any remaining proceeds are then applied against the accounts 60-63 with outstanding balances of more than $20.00 on a ratable basis. The $20.00 line of demarcation utilized in steps 154 and 156 is for exemplary purposes only—in accordance with the contractual Agreement example provided and discussed below. The line of demarcation may be any contractually stipulated amount. Finally, at step 158, any interest income generated in a Patient Account 20 is distributed among the provider-patient accounts 60-63 on a ratable basis.

If, as shown at step 166, a timely, periodic payment is not received from the patient/responsible party 25, a late payment/past due account resolution/collection process, in accordance with the rules and regulations provided to all patients/responsible parties 25 (see step 118 in FIG. 3), is initiated at step 168.

With reference to FIGS. 1 and 2, the payment management system 15 permits patients 25 to charge all out-of-pocket expenses for medical goods or services from different providers 30-33 to one convenient Patient Account 20, thereby reducing patient/responsible party 25 confusion and permitting a single monthly payment. The system and method of the present invention includes a flexible revolving credit program with reasonable interest rates. For example, if a patient 25 incurs additional charges or insurance pays more (or less), the balance due is automatically adjusted or additional credit is extended to the patient/responsible party 25. The present invention refunds to patients/responsible parties 25 any previously paid interest that is subsequently paid by a third party and provides real-time (i.e. on-line) coordination of multiple bills for one or more family members.

With “ownership” proportional according to account balance owed to provider, each Patient Account 20 is “owned” by all healthcare providers 30-33 delivering services to that patient 25 in accordance with a mutually agreed upon (i.e. contractual agreement) proration of their respective interests. Additionally, the providers 30-33 receive all interest income generated in Patient Accounts 20. By centralizing certain account management functions, each of the providers 30-33 is spared the costs of establishing a Patient Account, the periodic mailing of invoices and processing of payments received (see discussion with respect to Tables 1-3 below), the dunning of past due accounts, and reviewing, validating, and submitting claims to Medicare and Medicaid for reimbursement of uncollectible patient-pay obligations. The present invention allows these functions to be performed with a consistent level of professionalism, up-to-date information technology, economies of scale, and proportional expense sharing among providers 30-33 to reduce operating expenses. There are no budgetary constraints or initial out-of-pocket expenses required to become a participant in the system and method of the present invention. The present invention automatically enrolls all patients/responsible parties 25, including existing self-pay balances, of participating healthcare providers 30-33.

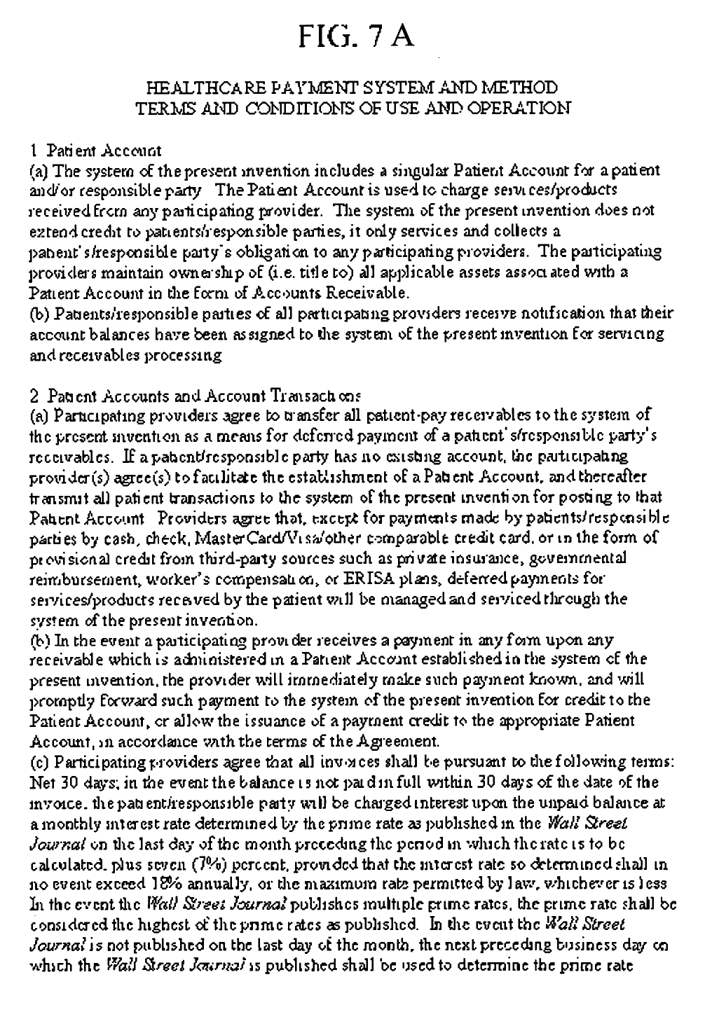

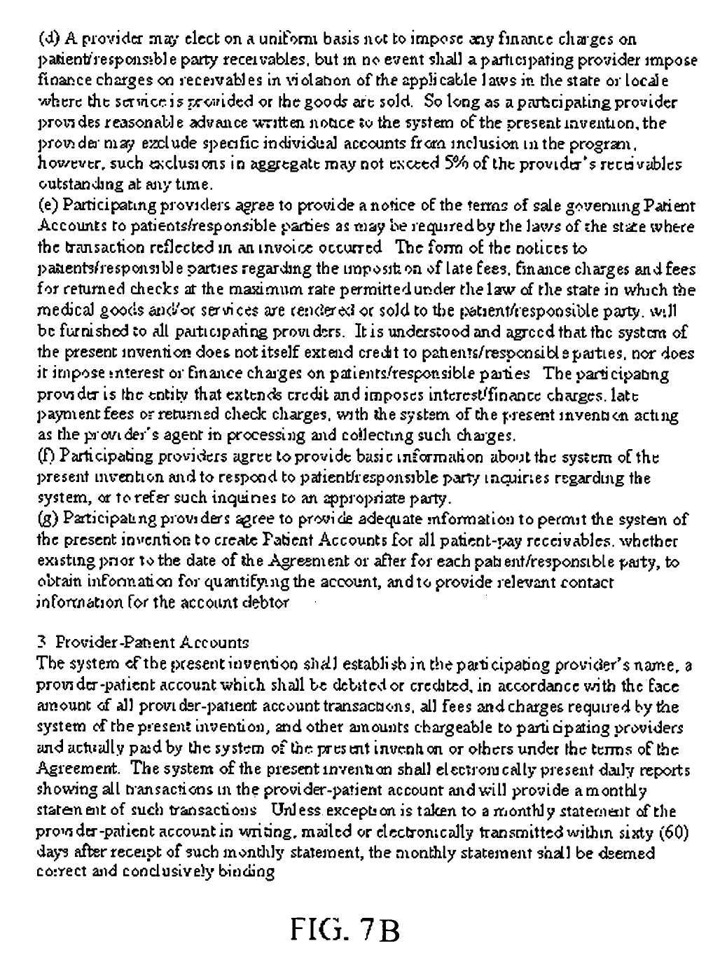

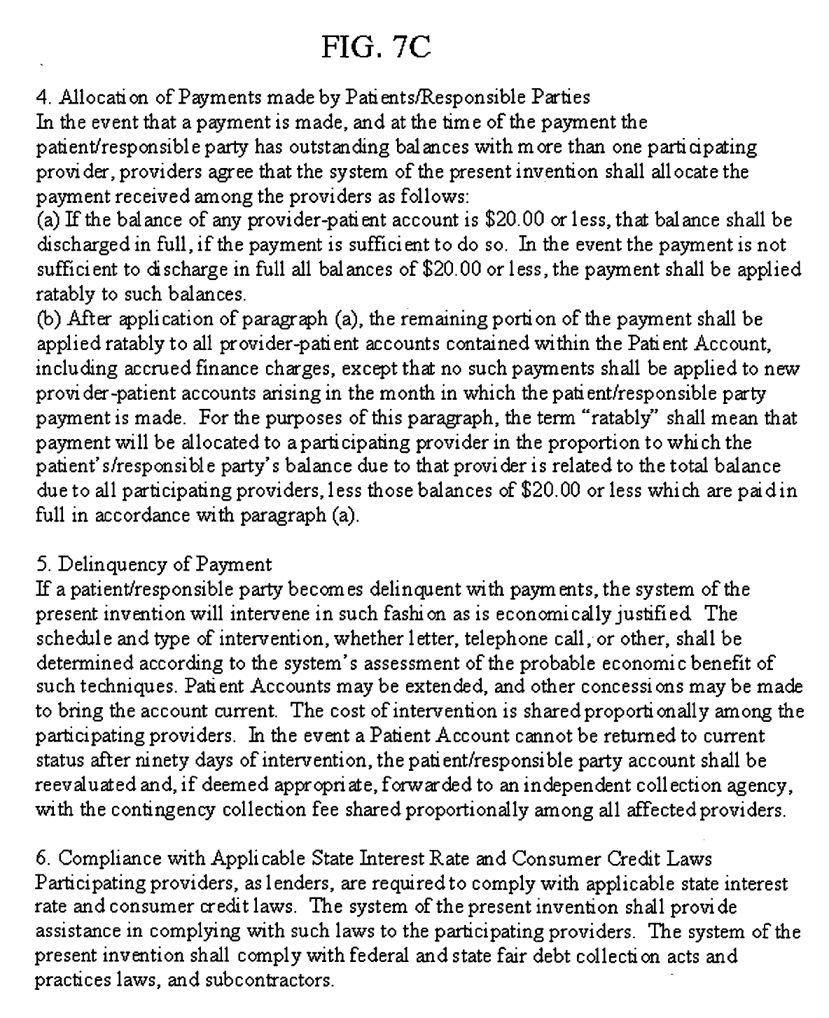

FIG. 7(A-C) is a generic example of a contractual Agreement used in the system and method of the present invention.

As indicated at steps 154 and 156 in FIG. 5, the present invention provides a method for applying payments from the patient/responsible party and/or other payors to providers based on specific contractual arrangements. The payment management method improves collections and produces more accurate financial reporting through the use of proven consumer credit technologies, systems, and structure (i.e. separate provisions/sets of parameters for creditworthy, as well as non-creditworthy, patients/responsible parties). The present invention objectively quantifies a patient's/responsible party's ability to pay health care expenses, and actively manages proportional expense sharing and lending among multiple providers, utilizing underlying patient-pay receivables. An example of the application of the present invention's method for applying patient/responsible party payments, based on specific pre-defined contractual arrangements (i.e. the example Agreement above), follows.

The present invention substantially reduces the transaction costs associated with the collection of patient-pay/responsible party receivables. In accordance with the present invention, each patient/responsible party receives a single monthly invoice for all balances, even though there may be multiple providers and/or multiple patients (i.e. multiple family member Patient Accounts that may be combined into a single invoice—such as one parent being the “responsible party” for the patient-pay costs associated with one or more children—nationally, there is an average of 2.5 accounts per responsible party) thereby further reducing periodic invoicing costs.

The tables included below are meant to demonstrate how proportional expense sharing functionality impacts certain costs. The tables do not reflect an attempt to identify/quantify all Patient Account-related expenses (e.g. new Patient Account set-up fees, account-on-file monthly maintenance fees, card issuance fees, participation fees).

Table 1 provides an example of an all-too-common, contemporary situation in which a patient/responsible party owes a total of $1,000.00 (patient-pay portion) to a total of five healthcare providers. Given the current, industry-acknowledged billing cost of $3.00-$5.00 per account per invoicing cycle, the current billing cost per invoicing period, using the low end of the range for illustrative purposes, is $15.00 (5 providers×$3.00). Table 2 illustrates the cost per patient/responsible party per invoicing cycle utilizing the present invention.

TABLE 1

| | | | |
|---|---|---|---|
| 1. Owes hospital | $350.00 | Billing cost = | $3.00 |
| 2. Owes pharmacy | $50.00 | Billing cost = | $3.00 |
| 3. Owes Dr. A | $350.00 | Billing cost = | $3.00 |
| 4. Owes Dr. B | $240.00 | Billing cost = | $3.00 |
| 5. Owes Dr. C | $10.00 | Billing cost = | $3.00 |
| TOTAL | $1,000.00 | Total billing cost = | $15.00 |

TABLE 2

| | |
|---|---|
| Billing costs | $0.35 |
| Remittance processing | $0.15 |
| costs/matched item | |
| Postage | $0.25 |
| Application of proceeds | $0.10 |
| TOTAL | $0.85 |

The billing, remittance, and postage costs shown in Table 2 represent amounts that may be achieved via utilization of the commercially-available services provided by the Regulus Group, LLC of Napa, Calif. The application of proceeds cost is a self-determined figure estimated by amortizing the processing of a reasonable number statements/payments over the wages paid to a team of data entry personnel. Comparison of the totals shown in Tables 1 and 2 shows a $14.15, or 94.3%, reduction in the cost per Patient Account per invoicing cycle. Additionally, as shown in Table 3, the resulting substantially reduced total transaction costs are shared proportionally by the multiple providers. Comparison of Tables 1 and 3 shows that utilization of the present invention results in each provider realizing a cost saving of $2.70 (90.0%) to $2.99 (99.7%) per Patient Account per invoicing cycle.

TABLE 3

| | | | | | | | | | |
|---|---|---|---|---|---|---|---|---|---|
| 1. Owes hospital | $350.00 | ÷ | $1,000.00 | = | 35% | × | $0.85 | = | $0.30 cost |
| 2. Owes pharmacy | $50.00 | ÷ | $1,000.00 | = | 5% | × | $0.85 | = | $0.04 cost |
| 3. Owes Dr. A | $350.00 | ÷ | $1,000.00 | = | 35% | × | $0.85 | = | $0.30 cost |
| 4. Owes Dr. B | $240.00 | ÷ | $1,000.00 | = | 24% | × | $0.85 | = | $0.20 cost |
| 5. Owes Dr. C | $10.00 | ÷ | $1,000.00 | = | 1% | × | $0.85 | = | $0.01 cost |
| TOTAL | $1,000.00 | | | | | | | | $0.85 |

Tables 4-7 provide an illustrative example of the operation of the present invention in relation to a credit-qualified (i.e. creditworthy) patient/responsible party. Table 4 shows a breakdown of a total of $1,000.00 (patient-pay portion) being owed to a total of five providers.

TABLE 4

| | |
|---|---|
| 1. Owes hospital | $350.00 |
| 2. Owes pharmacy | $50.00 |
| 3. Owes Dr. A | $350.00 |
| 4. Owes Dr. B | $240.00 |
| 5. Owes Dr. C | $10.00 |
| TOTAL | $1,000.00 |

For illustrative purposes, assume that a patient received the $1,000.00 of services/products from the five providers on Day 1. On Day 2 (i.e. the next business day), 100% of the charges are deposited to the various providers' accounts because the patient/responsible party is credit-qualified. As the patient tenders payment the cash will be applied to the loan.

This is illustrated in Tables 5-7 which show the distribution of $100.00 payments received from the patient/responsible party on Day 60 and Day 90, respectively, (i.e. the ends of two successive invoicing cycles that began with the issuance of invoices on Day 31 and Day 61, respectively).

TABLE 5

| | Patient | Provider | | | | Patient | Provider |
|---|---|---|---|---|---|---|---|
| | Account | loan | | | | Account | loan |
| | balance | balance | | Interest | Interest | balance | balance |
| | (Day 2) | (Day 2) | Payment | expense | income | (Day 30) | (Day 30) |
| 1. Hospital | $350.00 | $350.00 | | $1.73 | | $350.00 | $351.73 |
| 2. Pharmacy | $50.00 | $50.00 | | $0.25 | | $50.00 | $50.25 |
| 3. Dr. A | $350.00 | $350.00 | | $1.73 | | $350.00 | $351.73 |
| 4. Dr. B | $240.00 | $240.00 | | $1.19 | | $240.00 | $241.19 |
| 5. Dr. C | $10.00 | $10.00 | | $0.05 | | $10.00 | $10.05 |
| TOTAL | $1,000.00 | $1,000.00 | | $4.95 | | $1,000.00 | $1,004.95 |

Table 5 shows the activity in the Patient Account and various provider accounts during the first thirty-day period subsequent to the patient's receipt of the services/products. No payment is received during this period because the initial invoice is not issued until Day 31 (i.e. the start of the next thirty-day billing cycle). The only activity is the accrual of interest expense which is determined using a rate of 6% per annum and a 365-day period. A daily interest expense is calculated based on the Patient Account balance on that day and summed throughout the term of the billing cycle. Then, to minimize the accumulation of daily rounding errors, a total interest expense is recalculated at the end of each billing cycle.

The Patient Account balance does not change throughout the first thirty-day cycle. However, the accrued interest expense is added into the provider's loan balance.

TABLE 6

| | Patient | Provider | | | | Patient | Provider |
|---|---|---|---|---|---|---|---|
| | Account | loan | | | | Account | loan |
| | balance | balance | | Interest | Interest | balance | balance |
| | (Day 31) | (Day 31) | Payment | expense | income | (Day 60) | (Day 60) |
| 1. Hospital | $350.00 | $351.73 | $31.78 | $1.74 | | $318.22 | $321.69 |
| 2. Pharmacy | $50.00 | $50.25 | $4.54 | $0.25 | | $45.46 | $45.96 |
| 3. Dr. A | $350.00 | $351.73 | $31.78 | $1.74 | | $318.22 | $321.69 |
| 4. Dr. B | $240.00 | $241.19 | $21.79 | $1.19 | | $218.21 | $220.59 |
| 5. Dr. C | $10.00 | $10.05 | $10.10 | $0.05 | | $0.00 | $0.00 |
| TOTAL | $1,000.00 | $1,004.95 | $100.00 | $4.97 | | $900.11 | $909.93 |

In Table 6, the Day 31 Patient Account and provider loan balance information rolls over from the Day 30 balances of Table 5. Note that, as specified in the exemplary Agreement included above, the loan balance related to Dr. C (i.e. the $10.10 balance on Day 60 equals the Day 31 balance of $10.05 plus the $0.05 interest expense for the second billing cycle) is paid-in-full out of the Day 60 payment. This is because the balance is $20.00 or less and the amount of the payment ($100.00) is sufficient to cover the entire balance. The remainder of the payment ($89.90) is then ratably applied to the remaining accounts. Specifically, the ratable payment of $31.78 to the Hospital, or Dr. A, is obtained by dividing the account balance ($350.00) by the total remaining balance ($990.00—due to the payment-in-full of Dr. C's account balance) and then multiplying by the payment remainder ($89.90).

The interest expense amounts are determined in accordance with the formula described above with respect to Table 5. There is no interest income in the first invoicing cycle due to the existence of a typical “grace period” wherein any amount paid in full within that first invoicing cycle does not generate any interest income for the various healthcare providers. The Patient Account balance on Day 60 is determined by subtracting the payment amount from the Day 31 account balance ($318.22=$350.00−$31.78). Finally, the provider loan balance on Day 60 is determined by subtracting the payment amount from the Day 31 loan balance and then adding the interest expense that accrued during the thirty-day period ($321.69=$351.73−$31.78+$1.74).

TABLE 7

| | Patient | Provider | | | | Patient | Provider |
|---|---|---|---|---|---|---|---|
| | Account | loan | | | | Account | loan |
| | balance | balance | | Interest | Interest | balance | balance |
| | (Day 61) | (Day 61) | Payment | expense | income | (Day 90) | (Day 90) |
| 1. Hospital | $318.22 | $321.69 | $35.35 | $1.59 | $3.92 | $286.79 | $287.93 |
| 2. Pharmacy | $45.46 | $45.96 | $5.05 | $0.23 | $0.57 | $40.97 | $41.14 |
| 3. Dr. A | $318.22 | $321.69 | $35.35 | $1.59 | $3.92 | $286.79 | $287.93 |
| 4. Dr. B | $218.21 | $220.59 | $24.24 | $1.09 | $2.69 | $196.66 | $197.44 |
| TOTAL | $900.11 | $909.93 | $100.00 | $4.50 | $11.10 | $811.21 | $814.44 |

In Table 7's accounting of the effects of the Day 90 payment, note that Dr. C has been deleted from the table due to the satisfaction of the account balance out of the Day 60 payment. The payment of $100.00 is ratably applied to each of the four remaining accounts because there are no account balances of $20.00 or less. The Day 61 Patient Account and provider loan balance information rolls over from the Day 60 balances of Table 6. The payment and interest expense amounts are determined as in Table 6. The interest income amounts are determined using a rate of 15% per annum and a 365-day period. A daily interest income is calculated based on the account balance on that day and summed throughout the term of the billing cycle. Then, to minimize the accumulation of daily rounding errors, a total interest income is recalculated at the end of each billing cycle. The Patient Account balance on Day 90 is determined by subtracting the payment amount from the Day 61 account balance and then adding the interest income that accrued during the thirty-day period ($286.79=$318.22−$35.35+3.92). Finally, the provider loan balance on Day 90 is determined by subtracting the payment amount from the Day 61 loan balance and then adding the interest expense that accrued during the thirty-day period ($287.93=$321.69−$35.35+$1.59).

Tables 8-10 provide an illustrative example of the operation of the present invention in relation to a credit non-qualified (i.e. non-creditworthy) patient/responsible party. Table 7 shows a breakdown of a total of $1,000.00 being owed to a total of five providers.

TABLE 8

| | |
|---|---|
| 1. Owes hospital | $350.00 |
| 2. Owes pharmacy | $50.00 |
| 3. Owes Dr. A | $350.00 |
| 4. Owes Dr. B | $240.00 |
| 5. Owes Dr. C | $10.00 |
| TOTAL | $1,000.00 |

For illustrative purposes, assume that a patient received the $1,000.00 of services/products from the five providers on Day 1. The charges are not deposited to the various providers' accounts because the patient/responsible party is not credit-qualified. As the patient tenders payment, proceeds will be deposited to, or on behalf of, the providers. This is illustrated in Tables 9 and 10 which show the distribution of $100.00 payments received from the patient/responsible party on Day 60 and Day 90, respectively, (i.e. the ends of two successive invoicing cycles that began with the issuance of invoices on Day 31 and Day 61, respectively).

Non-qualified accounts are post-funded accounts. Consequently, “Interest expense” and “Provider loan balance” are not applicable and those columns are not included in Tables 9 and 10. The payment management system of the present invention simply “services” non-qualified/post-funded accounts (i.e. collects payments from patients/responsible parties and distributes the payments among all affected providers).

TABLE 9

| | | | | Patient |
|---|---|---|---|---|
| | Patient Account | | | Account |
| | balance (Day 1 | | Interest | balance |
| | and Day 31) | Payment | income | (Day 60) |
| 1. Hospital | $350.00 | $31.82 | | $318.18 |
| 2. Pharmacy | $50.00 | $4.54 | | $45.46 |
| 3. Dr. A | $350.00 | $31.82 | | $318.18 |
| 4. Dr. B | $240.00 | $21.82 | | $218.18 |
| 5. Dr. C | $10.00 | $10.00 | | $0.00 |
| TOTAL | $1,000.00 | $100.00 | | $900.00 |

In Table 9, note that, due to the lack of any activity (i.e., no loan exists, therefore no interest expense accrues) in the accounts during the first thirty-day period, the Patient Account balances for Day 1 and Day 31 have been consolidated in a single column. Further, as specified in the exemplary Agreement included above, the account balance related to Dr. C is paid-in-full out of the Day 60 payment. This is because the account balance is $20.00 or less and the amount of the payment ($100.00) is sufficient to cover the entire balance. The remainder of the payment ($90.00) is then ratably applied to the remaining accounts. Specifically, the ratable payment of $31.82 to the Hospital, or Dr. A, is obtained by dividing the account balance ($350.00) by the total remaining balance ($990.00—due to the payment-in-full of Dr. C's account balance) and then multiplying by the payment remainder ($90.00). There is no interest income in the first invoicing cycle due the existence of a typical “grace period” wherein any amount paid in full within one billing cycle does not generate any interest income for the various healthcare providers. Finally, the Patient Account balance on Day 60 is determined by subtracting the payment amount from the Day 31 account balance ($318.18=$350.00−$31.82).

TABLE 10

| | Patient | | | Patient |
|---|---|---|---|---|
| | Account | | | Account |
| | balance | | Interest | balance |
| | (Day 61) | Payment | income | (Day 90) |
| 1. Hospital | $318.18 | $35.35 | $3.92 | $286.75 |
| 2. Pharmacy | $45.46 | $5.05 | $0.56 | $40.97 |
| 3. Dr. A | $318.18 | $35.35 | $3.92 | $286.75 |
| 4. Dr. B | $218.18 | $24.25 | $2.69 | $196.62 |
| TOTAL | $900.00 | $100.00 | $11.09 | $811.09 |

In Table 10's accounting of the effects of the Day 90 payment, note that Dr. C has been deleted from the table due to the satisfaction of the account balance out of the Day 60 payment. The payment of $100.00 is ratably applied to each of the four remaining accounts because there are no account balances of $20.00 or less. The Day 61 Patient Account balance information rolls over from the Day 60 balance of Table 9. The interest income amounts are determined using a rate of 15% per annum and a 365-day period. A daily interest income is calculated based on the account balance on that day and summed throughout the term of the billing cycle. Then, to minimize the accumulation of daily rounding errors, a total interest income is recalculated at the end of each billing cycle. Finally, the Patient Account balance is determined by subtracting the payment amount from the account balance, and then adding the interest income ($286.75=$318.18−$35.35+$3.92).

In the method of the present invention, a current Patient Account 20 requires no intervention. However, an account becomes past due if a payment is not made within thirty days of its due date. A “past due” account status initiates certain intervention steps as defined in the applicable Agreement (FIG. 7). The goal of the intervention process is to bring the account current for a reasonable cost. The cost to bring an account current is dependent upon the action deemed appropriate (e.g. collection letters, multiple telephonic contacts, etc.). After three months of unsuccessful intervention attempts, an account remaining past due will be turned over to an independent collection agency. Any other Patient Account expenses (e.g., late charges, returned check fees) are proportionally shared among any affected providers.

In an effort to minimize issues of non-payment, the present invention's independent, third-party system and method analyzes each patient's/responsible party's ability to pay and is structured to collect either 95% of a patient's healthcare expenses based on that ability to pay, or an amount determined by public (i.e., CMS) policy. The present invention provides healthcare providers and society in general with the comfort of knowing that those who have used the healthcare system are paying their fair share according to their ability.

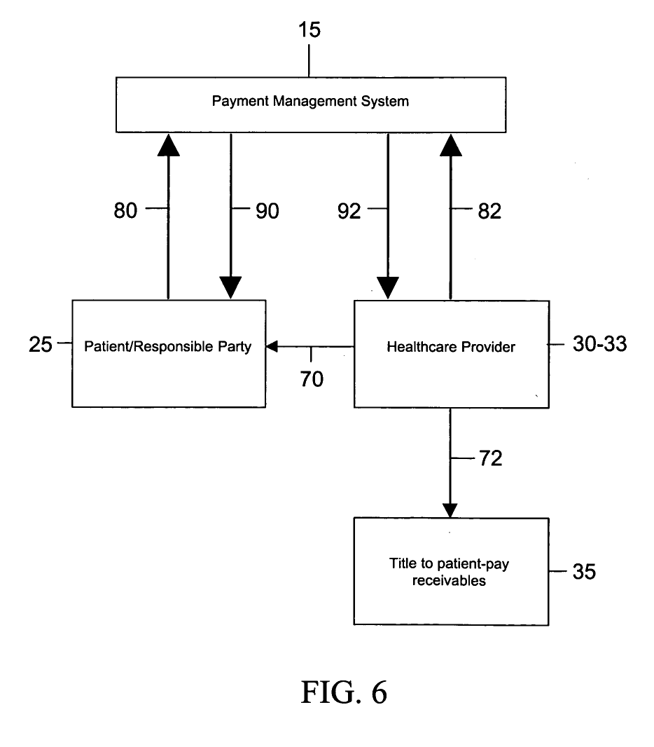

In summary, as shown in the schematic of FIG. 6, the payment management system 15 of the present invention serves as an intermediary between a patient/responsible party 25 and a plurality of providers 30-33 with respect to the patient-pay portion of the costs of healthcare products and services. As indicated by arrow 72, title to a provider's patient-pay receivables 35 does not transfer to the payment management system 15. Arrow 70 represents certain tangible and intangible items flowing from a healthcare provider 30-33 to a patient/responsible party 25. The items include healthcare products and/or services, the extension of credit to cover any patient-pay receivables, and any decisions relating to the imposition of charges/interest on past due accounts.

Arrow 82 represents certain tangible and intangible items flowing from a healthcare provider 30-33 to the payment management system 15. The items include the transfer of all patient/responsible party 25 account data from a healthcare provider 30-33 to the payment management system 15 when the provider 30-33 decides to make use of the present invention to manage his/her/its patient-pay receivables (i.e., enrolls), and cost information associated with any products and/or services subsequently supplied to the patient 25. Arrow 92 represents certain tangible and intangible items flowing from the payment management system 15 to a healthcare provider 30-33. The items include real-time access to current patient/responsible party 25 account data, receipt of appropriate (i.e. ratable) portions of all periodic payments made by a patient/responsible party 25 (subject to any contractual Agreement's Terms and Conditions), and receipt of any appropriate interest income generated in a patient's/responsible party's account.

Arrow 90 represents certain tangible and intangible items flowing from the payment management system 15 to a patient/responsible party 25. The items include written notification, at the time the Patient Account is established, of all applicable rules and regulations (e.g., late payment definition/penalties, financing/interest rate, minimum periodic finance charge), periodic invoices, and real-time access to current patient/responsible party 25 account data. Arrow 80 represents the periodic payments forwarded by a patient/responsible party 25 to the payment management system 15.

The present invention provides a variety of benefits to patients/responsible parties, participating healthcare providers, and the government. Patient/responsible party benefits include a quantitative analysis in order to establish financial capacity, establishment of an obligation consistent with financial capacity as defined by recognized and accepted financial practices (a requirement that one pays only his/her “fair share”), a complete record of all out-of-pocket expenses requiring only a single statement/payment, and a revolving credit facility. Participating healthcare provider benefits include reduced paperwork and operating expense, a rationalization of typically unpredictable income from patient-pay receivables, automatic regulatory compliance with respect to bad debts and charitable service expenses, and a “best practices” management of patient-pay receivables resulting in a previously unavailable degree of liquidity in those assets. Finally, government benefits include a quantitative analysis to establish equitable financial capacity for personal financial responsibility of patients/responsible parties, personal financial responsibility established in accordance with public policy, an increased realization rate (i.e. collections) of patient-pay receivables, an audit trail for regulatory compliance, reduced paperwork/operating expenses, and a more efficient and effective system.

The present invention possesses applications beyond the field of healthcare. The central element/feature is the establishment and management of a single, product/service receiver-centric account jointly owned, as defined in a contractual agreement, by a set of product/service providers. It may be applied in any business scenario where interrelated products/services are essential and indivisible (e.g. one would never have surgery without anaesthesia). Those scenarios make it possible, practical, and extremely beneficial to have one account per product/service receiver. All product/service providers benefit from the elimination of redundant processes such as the mailing of invoices, the processing of payments, and the dunning of past due accounts.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. A payment management system, comprising:
a computer Internet-communication backbone;
a web-enabled central database for storing account data;
a plurality of payors each having real-time network access to said central database via a secure connection over said Internet backbone;
a plurality of payees each having real-time network access to said central database via a secure connection over said Internet backbone;
a credit reporting service readily accessible by said central database via a secure connection over said Internet backbone;
a payor-centric account stored on said database, said payor-centric account comprising a plurality of individual payor-payee accounts;
whereby any of said plurality of payees may access their individual payee data in the payor-centric account stored on said database in real-time; and
said payors may access their payees data stored on said database in real-time but cannot access other payor's payor-payee account data.

2. The payment management system according to claim 1, further comprising an enrollment interface for allowing additional providers to enroll in the payment management system and submit their own provider-patient accounts to the payor-centric account, and comparison software for comparing and linking each newly submitted provider-patient account to existing related provider-patient accounts already in said payor-centric account database.

3. A method for managing deferred payments between a single service/product receiver (payor) and two or more product/service providers (payees), comprising the steps of:
enrolling a plurality of payees having payor/payee accounts receivable data;
forwarding each newly-enrolled payor/payee receivables data to a central database;
organizing said payor/payee receivables data into a plurality of payor-centric accounts, and a plurality of payor-payee accounts within each of said plurality of payor-centric accounts;
notifying all payors as to the existence of said plurality of payor-centric accounts and said plurality of payor-payee accounts;
providing each payor access, in real-time via one or more secure Internet connections, to all data contained within their respective payor-centric and payor-payee accounts;
providing payee access, in real-time via one or more secure Internet connections, to all data contained within their respective payee accounts;
said payors selectively and compulsorily delivering products and/or services to said payees;
charging all payor-responsible costs for payor-supplied products and/or services to an appropriate payor-payee account;
forwarding periodic invoices to all payors;
applying any payments received from payors to appropriate payor-centric and payor-payee accounts on a ratable basis; and
forwarding any interest income generated in said payor-centric and payor-payee accounts to said plurality of payees on a ratable basis.

4. The method for managing deferred payments according to claim 3, wherein said products and/or services are healthcare products/services, said payees are healthcare providers, and said payor is a patient.

5. The method for managing deferred payments according to claim 4, wherein said step of charging all payor-responsible costs for payee-supplied products and/or services to an appropriate payor-payee account comprises determining whether said products and/or services are elective in nature.

6. The method for managing deferred payments according to claim 5, further comprising said providers reviewing status of the patient's provider-patient account in real-time before providing said service/product.

7. The method for managing deferred payments according to claim 5, further comprising said providers obtaining outstanding balance and/or ability-to-pay information from a third party credit bureau before providing said service/product.

8. The method for managing deferred payments according to claim 5, wherein if the status of the provider-patient account is found to be unacceptable the provider may elect not to supply the patient with any products or services.

9. The method for managing deferred payments according to claim 8, wherein if the products/services required by the patient are non-elective in nature, the provider must supply those products and/or services to the patient.

10. The method for managing deferred payments according to claim 6, wherein said step of applying any payments received from patients to appropriate payor-centric and payor-payee accounts on a ratable basis further comprises applying proceeds of that payment against provider-patient accounts with outstanding balances below a pre-contracted threshold.

11. The method for managing deferred payments according to claim 10, wherein if the payment proceeds are insufficient to satisfy all of the payor-payee accounts with outstanding balances below said pre-contracted threshold, the proceeds are distributed among those accounts on a ratable basis.

12. The method for managing deferred payments according to claim 10, wherein if the payment proceeds are more than enough to satisfy all of the payor-payee accounts with outstanding balances below said pre-contracted threshold, any surplus proceeds are applied against accounts with outstanding balances above said pre-contracted threshold on a ratable basis.

13. The method for managing deferred payments according to claim 10, wherein any interest income generated by a payor-payee account is distributed among the payor-payee accounts on a ratable basis.

14. The method for managing deferred payments according to claim 4, wherein said payees are contractually given legal ownership of each payor/payee account in proportion to the account balance owed to said payee.
